(19) United States
(12) Patent Application Publication
(10) Pub. No.: US 2008/0008375 A1
(43) Pub. Date: Jan. 10, 2008

(54) METHOD FOR INSPECTING SURFACE TEXTURE DIRECTION OF WORKPIECES

(76) Inventor: Russell H. Petersen, Howell, MI (US)

Correspondence Address: Robert L. Stearns;Dickinson Wright PLLC, 38525 Woodward Avenue, Ste. 2000, Bloomfield Hills, MI, 48304-2970, US

(21) Appl. No.: 11/428,974

(22) Filed: Jul. 6, 2006

(51) Int. Cl. G06K 9/00

(52) U.S. Cl. 382/141

(57) ABSTRACT

A method of detecting defects in a workpiece having a surface with directional surface texture, comprises taking a gray scale photo image of the surface and assigning a brightness value to the pixels of the image. The brightness values of neighboring groups of the pixels are compared to develop brightness slope values of the neighboring groups. The image is then transformed so that the individual brightness values of the pixels are replaced with the associated brightness slope values representing the rotational direction of the brightness slope in degrees. Missing gradient information and/or changes in gradient direction are detected as flaws in the surface.

### BACKGROUND OF THE INVENTION

1. Technical Field

This invention relates generally to machine vision inspection systems and particularly to such systems used to inspect surface texture of workpieces.

2. Related Art

Various machine vision inspection systems are known for use in inspecting surfaces of workpieces to determine whether they conform to acceptable predetermined standards. Some workpieces have surface characteristics which may make it difficult to utilize automated inspection systems to inspect the parts. One such type of workpiece is a piston ring. At least for some rings, a final step in the manufacturing process involves grinding the side faces of the rings to provide a desired finish to the surfaces. The rings may be supported on a conveyor line and moved past a grinding wheel which imparts a ground texture to the surface that is monodirectional in nature (i.e., the scratches from grinding are aligned and generally parallel across the face of the surface). These surfaces may further be coated and may retain the underlying texture of the surface.

In the case of piston rings, various things can happen during manufacturing and processing that can result in a defective surface finish. Examples of such defects include: pits, voids, holes, chips, gouges, scratches, cracks, inclusions, and stains. These types are often detectible as presenting a sudden color or brightness change in relation to the directional texture of the surface. It is conceivable that some vision inspection systems would be capable of detecting such defects, such as those using Fourier transform (e.g., FFT), although many of these systems would have practical limitations for incorporation into a high speed ring production line since their processes rely on complex mathematical algorithms and would require excessive time and costly processors to operate. The requirement for a separate slower moving inspection line would not be desirable from the standpoint of cost, labor and floor space.

A particular challenge arises when inspecting such rings for a defect known in the art as a scrape. A scrape is a region of the surface that has the same texture as the rest of the ring but which has a different direction. This flaw can occur during processing as a result of the ring shifting during grinding. The texture can start out in one direction across the surface and, at the point of the shift, can continue across the surface in a different direction. This particular defect presents a problem to automated inspection systems since the texture is uniform (albeit in two or more directions) and there is typically no discernable color change or brightness change since the texture is uniform. As a result of the numerous defects that can occur in the manufacture of piston rings, including some flaws that are not able to be detected by available, practical machine vision systems, the inspection of piston rings is often performed manually by a skilled workforce with a trained eye for the flaws. This is, of course, labor intensive and costly but presently necessary to meet 100% inspection requirements.

### SUMMARY OF THE INVENTION

A method of inspecting a workpiece having a directional surface texture includes taking a gray scale image of the surface to develop pixels of the image having associated brightness values. The brightness values of neighboring groups of pixels are compared and analyzed to develop a characteristic brightness slope across the neighboring pixel groups corresponding to a direction of texture. The method involves detecting any notable changes in the brightness slope corresponding to an associated defect in the surface.

Of the flaws mentioned above, all would produce a change in brightness slope, including a scrape. As such, the method has the advantage of being adaptable for detecting all of the defects that may occur in the textured directional surface of a workpiece, such as the ground faces of piston rings. The processing of the information can be carried out very simply and quickly, making the system readily adaptable for in-line automated inspection of surfaces of workpieces during their manufacture. In the case of piston rings, the system could be placed at or near the end of the processing line to provide automated final surface inspection of 100% of the rings being manufactured. This could minimize or eliminate the need for manual inspection and could improve the consistency and reliability of the inspection process.

### BRIEF DESCRIPTION OF THE DRAWINGS

These and other features and advantages of the present invention will become more readily appreciated when considered in connection with the following detailed description and appended drawings, wherein:

FIG. 1 is a schematic plan view of a piston ring having monodirectional texture;

FIG. 2 is a view like FIG. 1 but schematically illustrating the condition of a scrape; and

FIG. 3 is an enlarged fragmentary view showing further details of the scraped region of FIG. 2.

### DETAILED DESCRIPTION OF THE PREFERRED EMBODIMENT

A representative workpiece to be inspected by the present invention is generally shown at 10 in the drawings and may comprise a piston ring. The piston ring 10 has opposite faces 12 (only one shown), an outer diameter surface 14 and an inner diameter surface 16.

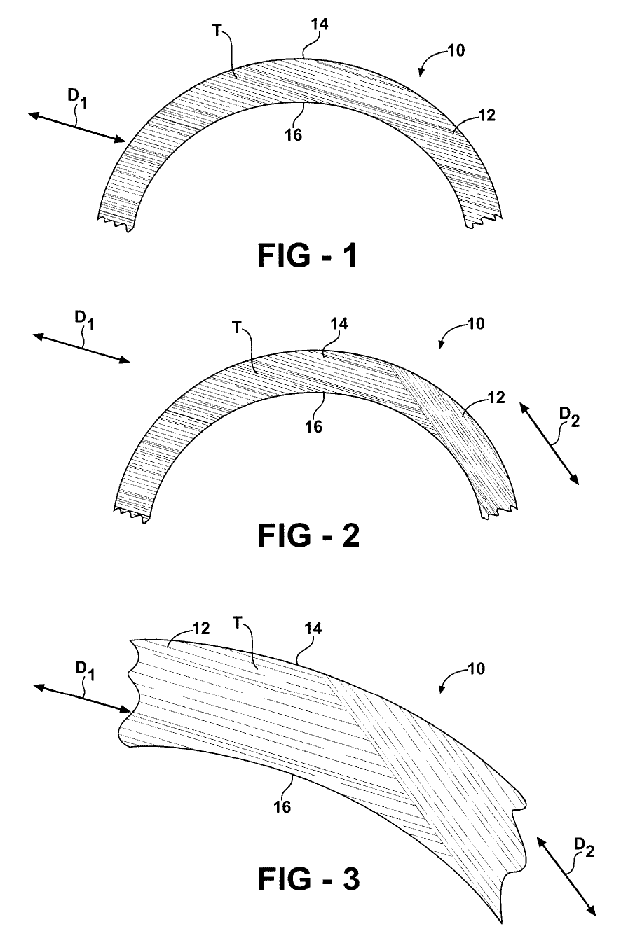

The faces 12 are finished, such as by grinding, so that the surface has a texture T that is aligned in a single direction D1 (i.e., monodirectional). This results from moving a rotating grinding wheel across the surface 12 in the direction D1 of the texture. In the case of high production piston rings, the rings 10 may be carried on a conveyor line and moved past the grinding wheel to impart the texture 10, as illustrated in FIG. 1. The surface 12 may be coated and may retain the underlying surface texture and direction.

If, during the grinding process, the ring 10 were to shift, for example if the leading end of the ring 10 started beneath the grinding wheel and then something happens to cause the ring 10 to rotate from its original position, the ring 10 will continue to pass beneath the wheel and its surface 12 ground, but the direction D2 of the texture will have changed. This condition results in a defect or flaw known as a scrape S which is illustrated in FIGS. 2 and 3. The present method provides a means of detecting the presence of a number of surface defects, including a scrape. Other such defects can include, but are not limited to: pits, voids, holes, chips, gouges, scratches, cracks, inclusions, and stains.

The inspection method includes taking a standard gray scale camera image of the surface 12 and assigning each pixel a brightness value. The image is scanned and small pixel neighborhoods (e.g., 2×2, 3×3, etc.) are analyzed to compare their relative brightnesses. This information is processed to develop an alternate image representing the geometric direction of brightness slope (gradient) in degrees. This image replaces the original brightness “value” of each pixel with a value that represents the rotational direction of brightness slope in degrees corresponding to the direction of the ground surface texture. The resulting image can be subsequently evaluated using a variety of well known procedures, such as blob analysis, morphology, histograms, and the like to recognize missing gradient (e.g., pits, scratches, cracks, voids, inclusions) and unwanted gradient direction or change in direction (i.e., a scrape). Thus, this process develops information about not only the texture and direction of the texture, but any changes in the texture or changes in direction in order to detect flaws in the surface 12. This process of detecting potential defects is logical rather than mathematical and can be executed at high speeds using a standard personal computer.

In practice, the workpieces 10 can be arranged on a conveyor line (e.g., a continuously moving belt or the like) and be advanced toward at least one camera that can be stationary. The camera is used to take the gray scale image of the surface 12 of each workpiece 10. One important advantage of this invention, apart from the ability to detect scrapes and its speed, is the ability to accommodate different orientations of the workpieces 10 presented to the camera. In other words, it is not necessary that the direction of the surface textures of the workpieces 10 be aligned or similarly oriented to accommodate any need of the camera of the processing system, but rather the texture directions can be randomly oriented among the workpieces. The process determines the brightness slope and direction and then detects any differences relative to this information, so that it is not dependant on starting with presenting the texture in any particular direction to the camera.

Obviously, many modifications and variations of the present invention are possible in light of the above teachings. It is, therefore, to be understood that within the scope of the appended claims, the invention may be practiced otherwise than as specifically described.

What is claimed is:

1. A method of detecting defects in a workpiece having a surface with directional surface texture, comprising:
taking a gray scale photo image of the surface and assigning a brightness value to the pixels of the image;
comparing the brightness values of neighboring groups of the pixels to develop brightness slope values of the neighboring groups and transforming the image so that the individual brightness values of the pixels are replaced with the associated brightness slope values representing the rotational direction of the brightness slope in degrees; and
detecting any missing gradient information or changes in gradient direction as flaws in the surface.

2. The method of claim 1 wherein the workpiece is advanced along a continuously moving conveyor line relative to at least one stationary camera used for taking the gray scale image.

3. The method of claim 1, wherein the workpieces are fed along the conveyor line with the rotational directions of the textured surfaces randomly presented.
